(19) United States
(12) Patent Application Publication
(10) Pub. No.: US 2024/0227858 A1
(43) Pub. Date: Jul. 11, 2024

(54) VEHICLE CONTROL DEVICE AND VEHICLE CONTROL METHOD

(71) Applicant: TOYOTA JIDOSHA KABUSHIKI KAISHA, Toyota-shi (JP)

(72) Inventor: Tomoya TAKEDA, Toyota-shi (JP)

(73) Assignee: TOYOTA JIDOSHA KABUSHIKI KAISHA, Toyota-shi (JP)

(21) Appl. No.: 18/464,347

(22) Filed: Sep. 11, 2023

(30) Foreign Application Priority Data
Jan. 10, 2023 (JP) 2023-001888

(51) Int. Cl. B60W 60/00

(52) U.S. Cl. CPC B60W 60/0016; B60W 2420/62; B60W 2530/00; B60W 2554/80

(57) ABSTRACT

The vehicle control device includes an acquisition unit that acquires detection results from a first monitoring sensor that monitors at least one of the front and rear of the vehicle, and a second monitoring sensor that monitors the side of the vehicle, and the first monitoring sensor, a recognition processing unit for recognizing moving objects located around the vehicle based on the detection results of the second monitoring sensor, an area setting unit for setting a predetermined monitoring area around the vehicle, and a moving object within the monitoring area, and a decision unit that decides to stop monitoring with the second monitoring sensor while continuing monitoring with the first monitoring sensor when the moving objects do not exist within a monitoring area.

### CROSS-REFERENCE TO RELATED APPLICATION

This application claims priority to Japanese Patent Application No. 2023-001888 filed on Jan. 10, 2023, incorporated herein by reference in its entirety.

### BACKGROUND

### 1. Technical Field

The present disclosure relates to a vehicle control device and a vehicle control method using the detection result of a monitoring sensor that monitors the sides of a vehicle.

### 2. Description of Related Art

Japanese Unexamined Patent Application Publication No. 2018-46424 (JP 2018-46424 A) discloses a camera monitor system including a side camera that captures an image of the exterior of an automobile, a side monitor that displays the captured image, a detection unit, and a control unit. The detection unit detects the state of the engine switch, the state of the engine, the state of the shift, the open/closed state of the door, and the seated state of the driver. The control unit controls power consumption of the side camera and the side monitor based on the detection output of the detection unit. This camera monitor system dims the side monitor after a predetermined time has passed since the gear shift is set to park, and bring the side monitor in the standby mode after a predetermined time has passed since the door is closed while the engine is off.

### SUMMARY

Many sensors are used for vehicle perimeter monitoring, and the total power consumption of these sensors can be large. Therefore, it is desirable to reduce the total power consumption of the sensors mounted on the vehicle.

An object of the present disclosure is to provide a technique for reducing the total power consumption of sensors mounted on a vehicle.

In order to solve the above problem, a vehicle control device according to an aspect of the present disclosure includes: an acquisition unit that acquires a detection result from a first monitoring sensor that monitors at least one of a front of a vehicle and a rear of the vehicle and a second monitoring sensor that monitors a side of the vehicle; a recognition processing unit that recognizes a moving object positioned around the vehicle based on the detection result of the first monitoring sensor and the second monitoring sensor; and a decision unit that decides to stop monitoring with the second monitoring sensor while continuing monitoring with the first monitoring sensor when the moving object does not exist within a monitoring area surrounding the vehicle.

Another aspect of the present disclosure is a vehicle control method. This method, each step of which is executed by a computer, includes: a step of acquiring a detection result from a first monitoring sensor that monitors at least one of a front of a vehicle and a rear of the vehicle and a second monitoring sensor that monitors a right side and a left side of the vehicle; a step of recognizing a moving object positioned around the vehicle based on the detection result of the first monitoring sensor and the second monitoring sensor; and a step of deciding to stop monitoring with the second monitoring sensor while continuing monitoring with the first monitoring sensor when the moving object does not exist within a monitoring area surrounding the vehicle.

According to the present disclosure, a technique for reducing the total power consumption of sensors mounted in a vehicle can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining the surroundings monitoring operation performed by the vehicle of the embodiment;

FIG. 2 is a diagram showing the functional configuration of the vehicle control device;

FIG. 3 is a diagram for explaining a monitoring area set around the vehicle of the embodiment; and

FIG. 4 is a flowchart of processing for stopping the second monitoring sensor.

### DETAILED DESCRIPTION OF EMBODIMENTS

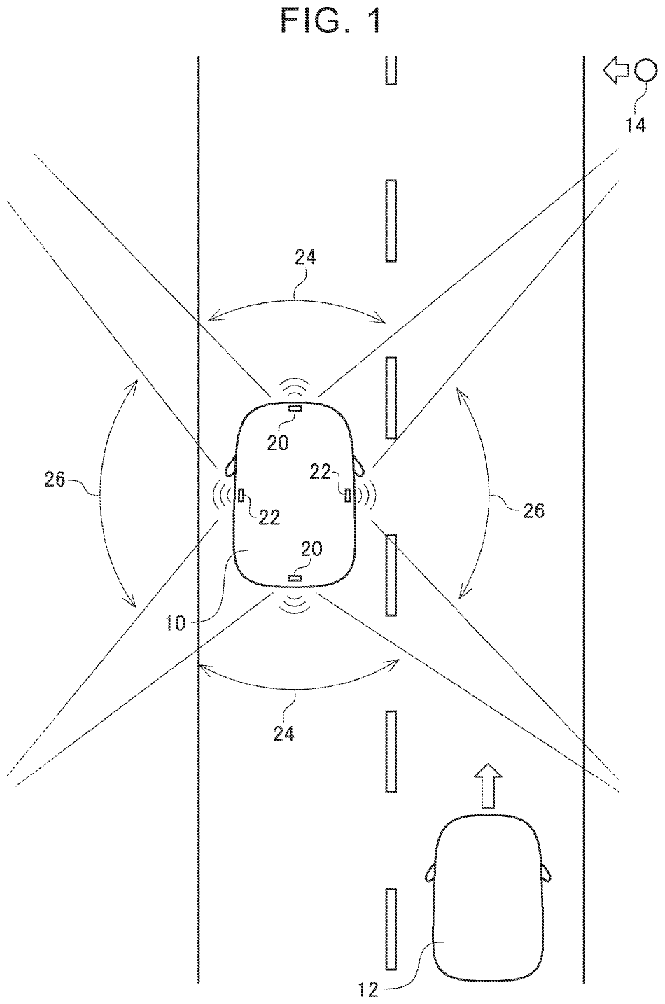

FIG. 1 is a diagram for explaining the surroundings monitoring operation performed by the vehicle 10 of the embodiment. The vehicle 10 can execute autonomous driving control for autonomously traveling, for example, control for maintaining the lane and traveling, and control for following the preceding vehicle.

The vehicle 10 is provided with a first monitoring sensor 20 that monitors the front or rear, and a second monitoring sensor 22 that monitors the sides. The lateral direction is perpendicular to the front-rear direction of the vehicle 10 and may be the right-left direction of the vehicle 10.

The first monitoring sensor 20 and the second monitoring sensor 22 may be at least one of an in-vehicle camera, millimeter wave radar, optical laser sensor, sound wave sensor, and the like. The first monitoring sensor 20 and the second monitoring sensor 22 detect objects located around the vehicle. Objects include moving objects such as other vehicles and pedestrians. The first monitoring sensor 20 and the second monitoring sensor 22 may each include multiple sensors. The second monitoring sensor 22 may include at least an optical laser sensor such as LiDAR. The first monitoring sensor 20 and the second monitoring sensor 22 maybe the same type of sensor or different types of sensors.

A first monitoring sensor 20 measures an object in a first measurement range 24. A second monitoring sensor 22 measures an object in a second measurement range 26. The first measurement range 24 is formed in a fan shape from the center of the front part or the center of the rear part of the vehicle 10. The second measurement range 26 is fan-shaped from the side of the vehicle 10. The first measurement range 24 and the second measurement range 26 may partially overlap. The second monitoring sensor 22 mainly measures laterally as shown in the second measurement range 26. For example, the first monitoring sensor 20 includes a monitoring sensor that measures the oblique right front of the vehicle 10 and monitors from the right front to the right side. The second monitoring sensor 22 maybe limited to the sensor of the same type as the first monitoring sensor 20, and may be provided for side monitoring separately from front and rear monitoring.

The detection results of the first monitoring sensor 20 and the second monitoring sensor 22 detect the presence of moving objects such as other vehicles 12 and pedestrians 14. Vehicle 10 is traveling in the left lane. Another vehicle 12 is behind the vehicle 10 and is traveling in the right lane so as to follow the vehicle 10. Pedestrian 14 is positioned right in front of vehicle 10 and is traveling leftward so as to approach the traveling direction of vehicle 10. In the autonomous driving control, the vehicle 10 recognizes surrounding moving objects and runs so as not to collide with the moving bodies.

Since many sensors of the vehicle 10 operate in autonomous driving control, the total power consumption may increase. Therefore, the vehicle control device of the vehicle 10 of the embodiment stops monitoring by the second monitoring sensor 22 when it is determined that a sufficient distance is secured from the moving object located in the vicinity, and the first monitoring sensor 20 only and monitor the surroundings. Thereby, the total power consumption in autonomous driving control can be reduced.

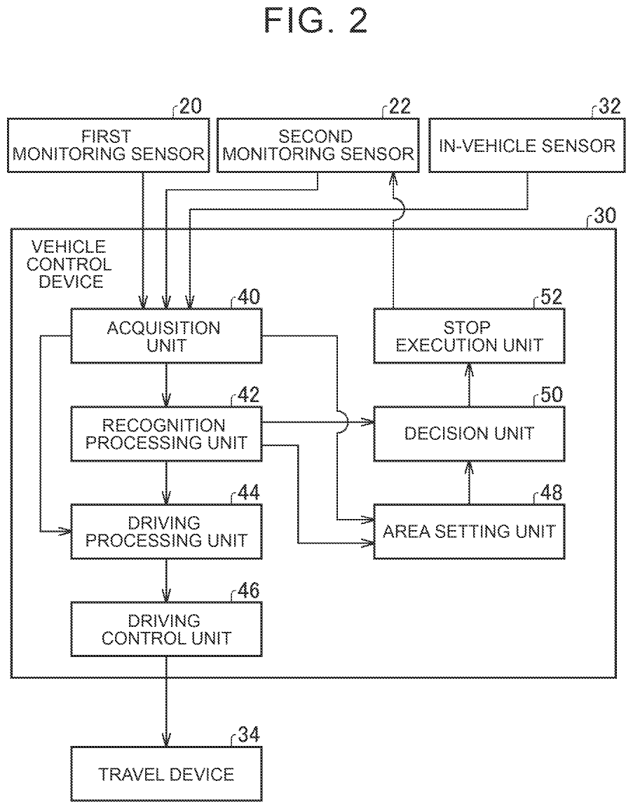

FIG. 2 is a diagram showing the functional configuration of the vehicle control device 30. Each function of the vehicle control device 30 can be configured by circuit blocks, memories, and other LSIs in terms of hardware. Each function of the vehicle control device 30 is implemented by system software, application programs, and the like loaded in the memory. Therefore, those skilled in the art will understand that each function of the vehicle control device 30 can be realized in various forms by hardware only, software only, or a combination thereof, and is not limited to either one.

The vehicle 10 is provided with a first monitoring sensor 20, a second monitoring sensor 22, a vehicle control device 30, an in-vehicle sensor 32 and a travel device 34. The first monitoring sensor 20 and the second monitoring sensor 22 transmit the results of detecting the surroundings of the vehicle 10 to the vehicle control device 30. The first monitoring sensor 20 and the second monitoring sensor 22 may transmit the information which shows the physical relationship of an object and the vehicle 10 to the vehicle control device 30 as information regarding an object. The first monitoring sensor 20 and the second monitoring sensor 22 may transmit simple sensor values to the vehicle control device 30 as information about the target object.

In-vehicle sensor 32 includes a running state detection sensor that detects the running state of vehicle 10 and an input sensor that receives an operation input from the driver. The running state detection sensors include a vehicle speed sensor, a steering angle sensor, an acceleration sensor, a brake pressure sensor, and the like, and transmit vehicle running state information to the vehicle control device 30. The input sensors may be touchpads, mechanical switches and/or microphones. An input sensor receives ON/OFF of autonomous driving control, and receives the destination information in automatic operation control.

The travel device 34 has a drive unit for applying a driving force to the wheels to rotate the wheels to advance the vehicle, a steering unit for steering the wheels, and a braking unit for applying braking force to the wheels. The drive unit may be an engine, a motor, or a combination thereof. The travel device 34 maybe driven by a driver's operation, or may be driven by autonomous driving control.

The vehicle control device 30 includes an acquisition unit 40, a recognition processing unit 42, a driving processing unit 44, a driving control unit 46, an area setting unit 48, a decision unit 50 and a stop execution unit 52. The acquisition unit 40 acquires detection results from the first monitoring sensor 20 and the second monitoring sensor 22. The first monitoring sensor 20 monitors at least one of the front and rear of the vehicle. The second monitoring sensor 22 monitors the sides of the vehicle. The detection result of the in-vehicle sensor 32 is acquired as the running state information.

The recognition processing unit 42 recognizes the position of the target object and the type of the target object based on the detection results of the first monitoring sensor 20 and the second monitoring sensor 22. Object types include automobiles, pedestrians, traffic signs, road installations, and the like. The recognition processing unit 42 calculates the distance between the object and the vehicle 10 and the direction from the vehicle 10 to the object as position information of the object.

The recognition processing unit 42 analyzes the image captured by the vehicle-mounted camera and identifies the type of the object. The recognition processing unit 42 may identify the type of the target object from the captured image using a neural network method, the recognition processing unit 42, for example, a deep learning method.

The recognition processing unit 42 attaches identification information to each object and tracks it. The recognition processing unit 42 identifies a moving object among the objects based on the tracking result of the position of the object. The recognition processing unit 42 may calculate the relative speed between the object and the vehicle 10 and determine whether the object is a moving object based on the relative speed. That is, the recognition processing unit 42 recognizes moving objects located around the vehicle 10 based on the detection results of the first monitoring sensor 20 and the second monitoring sensor 22.

The driving processing unit 44 receives an instruction to start the autonomous driving control from the driver and executes processing for autonomously driving the vehicle 10. The driving processing unit 44 calculates a target vehicle speed, a target steering angle, and a target braking force based on the detection result of the in-vehicle sensor 32 and the recognition result of the recognition processing unit 42. For example, the driving processing unit 44 calculates the target vehicle speed so as to follow the preceding vehicle, and calculates a preset target vehicle speed if there is no preceding vehicle.

The driving control unit 46 controls the travel device 34 according to the target vehicle speed, target steering angle, and target braking force calculated by the driving processing unit 44. The travel device 34 is driven under the control of the driving control unit 46. Thereby, the vehicle control device 30 can autonomously drive the vehicle 10.

The area setting unit 48 sets a predetermined monitoring area surrounding the vehicle 10. This monitoring area will be explained with reference to new drawings.

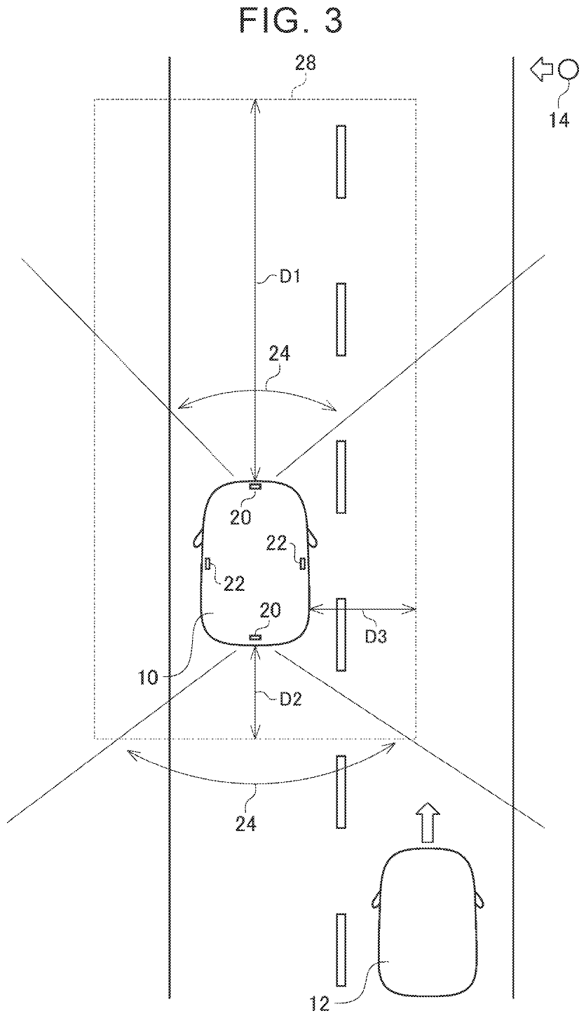

FIG. 3 is a diagram for explaining the monitoring area 28 set around the vehicle 10 of the embodiment. A monitoring area 28 is shown in the area enclosed by the dotted line in FIG. 3. Although the monitoring area 28 is set in a rectangular shape in FIG. 3, the monitoring area 28 maybe trapezoidal. Monitoring area 28 maybe of a predetermined size and shape.

The monitoring area 28 extends forward of the vehicle 10 by a distance D1, extends rearward of the vehicle 10 by a distance D2, and extends laterally of the vehicle 10 by a distance D3. The monitoring area 28 is variably set according to the driving conditions and the surrounding environment. The distance D1 in front of the vehicle 10 is set longer than the distance D2 in the rear and the distance D3 in the side, and may be set several times or more. The rear distance D2 and the side distance D3 may be substantially the same.

The area setting unit 48 sets the size of the monitoring area 28 based on the running state information detected by the in-vehicle sensor 32. The running state information is, for example, the vehicle speed of the vehicle 10. The monitoring area 28 maybe set to increase as the vehicle speed of the vehicle 10 increases. The monitoring area 28 maybe set to increase stepwise according to the vehicle speed of the vehicle 10. Also, the driving state information may include the braking performance of the vehicle 10. In this way, the monitoring area 28 is appropriately set according to the running state. Note that the area setting unit 48 may set the size of the monitoring area 28 according to the weather and/or the time of day.

The area setting unit 48 may set the size of the monitoring area 28 according to the type of moving object recognized by the recognition processing unit 42. For example, when the type of moving object existing around the vehicle 10 is only a vehicle, the monitoring area 28 is set to be larger than when pedestrians are present. This is because pedestrians are less likely to suddenly enter the monitoring area 28 because their acceleration is lower than that of vehicles. The area setting unit 48 may individually set the distance D1 in front of the vehicle 10, the distance D2 in the rear, and the distance D3 in the side of the vehicle 10 according to the position of the moving object and the type of the moving object.

Return to FIG. 2. When no moving object exists within the monitoring area 28, the decision unit 50 determines to stop monitoring by the second monitoring sensor 22 while continuing monitoring by the first monitoring sensor 20. Stopping the monitoring by the second monitoring sensor 22 maybe either stopping the recognition process or stopping the power supply. When no moving object exists within the monitoring area 28, the decision unit 50 determines to stop monitoring by both the left and right second monitoring sensors 22 as shown in FIG. 3. In addition, when the moving object does not exist on either the left side or the right side of the vehicle, the decision unit 50 may determine to stop the second monitoring sensor 22 on the side where the moving object does not exist.

The stop execution unit 52 receives the determination result of the decision unit 50 and instructs to stop monitoring by the second monitoring sensor 22. The stop execution unit 52 instructs the recognition processing unit 42 not to recognize the detection result of the second monitoring sensor 22. As a result, the processing load on the recognition processing unit 42 is reduced, and power consumption can be suppressed.

As shown in FIG. 3, the decision unit 50 determines to turn off the power of the second monitoring sensor 22 when the moving object does not exist within the predetermined monitoring area 28. The stop execution unit 52 instructs the second monitoring sensor 22 to turn off the power. As a result, power consumption during autonomous driving can be reduced. Also, the useful life of the second monitoring sensor 22 can be extended. Extending the useful life of the expensive sensor is useful when the second monitoring sensor 22 is an optical laser sensor.

In the case where the second monitoring sensor 22 include a plurality of monitoring sensors, the decision unit 50 may determine to turn off all the second monitoring sensors 22 when the moving object does not exist within the monitoring area 28.

If the moving object exists within the monitoring area 28, the decision unit 50 continues monitoring with the first monitoring sensor 20 and the second monitoring sensor 22.

When the moving object does not exist in the monitoring area 28 and the decision unit 50 determines that there is a moving object entering the monitoring area 28 within the predetermined time, the first monitoring sensor 20 and the second monitoring sensor 22 You may continue to monitor. The predetermined time is set, for example, to several seconds. The decision unit 50 first determines whether a moving object exists within the monitoring area 28. If the moving object does not exist within the monitoring area 28, the decision unit 50 determines whether there is a moving object entering the monitoring area 28 within several seconds. When it is determined that no moving object exists within the predetermined monitoring area 28 and that there is no moving object entering the monitoring area 28 within several seconds, the decision unit 50 continues monitoring the first monitoring sensor 20. While doing so, it decides to stop monitoring by the second monitoring sensor 22. The decision unit 50 determines whether or not there is a moving object entering the monitoring area 28 after a predetermined time based on the relative speed between the moving object and the vehicle 10. As a result, the vehicle control device 30 can stop the second monitoring sensor 22 in consideration of the prediction of the entrance of the moving object.

When the moving object enters the monitoring area 28 while the second monitoring sensor 22 is stopped, the decision unit 50 determines to resume monitoring by the second monitoring sensor 22. The stop execution unit 52 receives the determination result of the decision unit 50 and turns on the power of the second monitoring sensor 22. Alternatively, when the decision unit 50 determines that the moving object will enter the monitoring area 28 within a predetermined period of time, it may determine to resume monitoring by the second monitoring sensor 22. Whether the moving object enters the monitoring area 28 within a predetermined time is determined based on the relative speed between the mobile body and the vehicle 10.

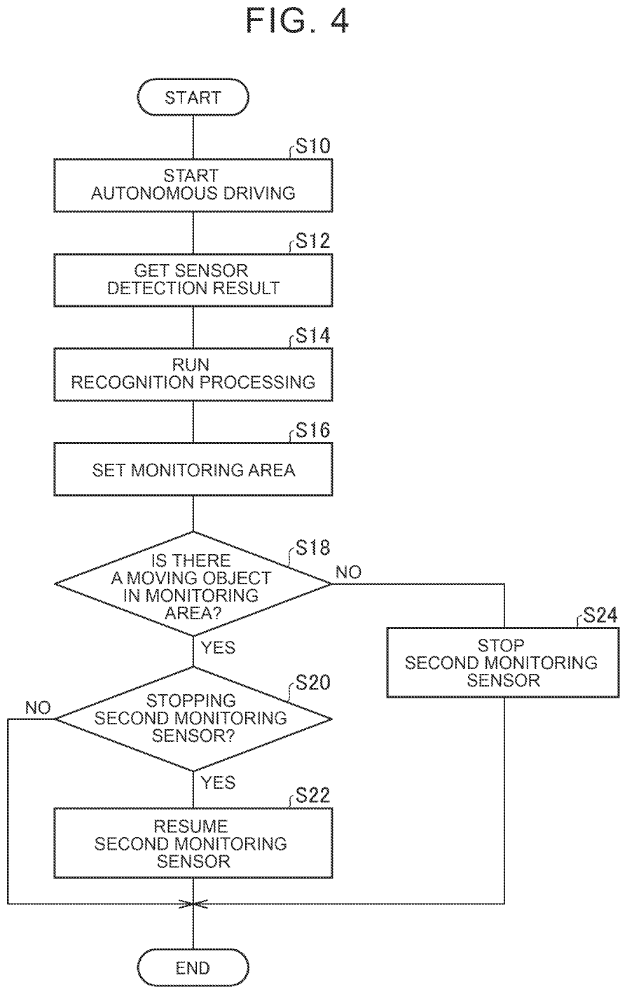

FIG. 4 is a flowchart of processing for stopping the second monitoring sensor 22. The processing shown in FIG. 4 is repeated periodically. The vehicle control device 30 receives an operation input from the driver and starts autonomous driving control (S10). The acquisition unit 40 acquires the detection results of the first monitoring sensor 20 and the second monitoring sensor 22 (S12). Note that if the second monitoring sensor 22 is powered off, the acquisition unit 40 acquires only the detection result of the first monitoring sensor 20.

The recognition processing unit 42 executes recognition processing based on the detection results of the first monitoring sensor 20 and the second monitoring sensor 22, and recognizes moving objects located around the vehicle 10 (S14). The area setting unit 48 sets the monitoring area 28 around the vehicle 10 (S16).

The decision unit 50 determines whether or not there is a moving object within the monitoring area 28 (S18). If there is no moving object within the monitoring area 28 (N of S18), the decision unit 50 determines to stop monitoring with the second monitoring sensor 22 while continuing monitoring with the first monitoring sensor 20. Then, the stop execution unit 52 stops the second monitoring sensor 22 (S24), and finishes this process. Note that when the second monitoring sensor 22 is stopped, either the recognition process is stopped or the power supply is stopped.

If there is a moving object within the monitoring area 28 (Y of S18), the decision unit 50 determines whether the second monitoring sensor 22 is stopped (S20). If the second monitoring sensor 22 is not stopped (N of S20), the monitoring of the first monitoring sensor 20 and the second monitoring sensor 22 is continued, and this process ends.

If the second monitoring sensor 22 is stopped (Y of S20), the decision unit 50 decides to resume monitoring with the second monitoring sensor 22. Then, the stop execution unit 52 activates the second monitoring sensor 22 (S22), and terminates this process.

The present disclosure has been described above based on the embodiments. The present disclosure is not limited to the above-described embodiments, and modifications such as various design changes can be added based on the knowledge of those skilled in the art.

In the embodiment, the mode in which the vehicle 10 is drivable by the driver has been shown, but it is not limited to this mode. For example, the vehicle 10 may be able to run only by autonomous driving control, and may not have a passenger.

What is claimed is:

1. A vehicle control device comprising:
an acquisition unit that acquires a detection result from a first monitoring sensor that monitors at least one of a front of a vehicle and a rear of the vehicle and a second monitoring sensor that monitors a side of the vehicle;
a recognition processing unit that recognizes a moving object positioned around the vehicle based on the detection result of the first monitoring sensor and the second monitoring sensor; and
a decision unit that decides to stop monitoring with the second monitoring sensor while continuing monitoring with the first monitoring sensor when the moving object does not exist within a monitoring area surrounding the vehicle.

2. The vehicle control device according to claim 1, further comprising an area setting unit that sets the monitoring area surrounding the vehicle, wherein:
the acquisition unit acquires traveling state information of the vehicle; and
the area setting unit sets a size of the monitoring area based on the traveling state information of the vehicle.

3. The vehicle control device according to claim 1, further comprising an area setting unit that sets the monitoring area surrounding the vehicle, wherein the area setting unit sets a size of the monitoring area in accordance with a kind of the moving object recognized by the recognition processing unit.

4. The vehicle control device according to claim 1, wherein:
the second monitoring sensor is an optical laser sensor; and
the decision unit decides to turn off a power source of the second monitoring sensor when the moving object does not exist within the monitoring area during autonomous driving control.

5. A vehicle control method, each step of which is executed by a computer, the vehicle control method comprising:
a step of acquiring a detection result from a first monitoring sensor that monitors at least one of a front of a vehicle and a rear of the vehicle and a second monitoring sensor that monitors a right side and a left side of the vehicle;
a step of recognizing a moving object positioned around the vehicle based on the detection result of the first monitoring sensor and the second monitoring sensor; and
a step of deciding to stop monitoring with the second monitoring sensor while continuing monitoring with the first monitoring sensor when the moving object does not exist within a monitoring area surrounding the vehicle.
